(19) United States
(12) Patent Application Publication
(10) Pub. No.: US 2025/0316836 A1
(43) Pub. Date: Oct. 9, 2025

(54) BATTERY PACK

(71) Applicant: SK On Co., Ltd., Seoul (KR)

(72) Inventors: Se Hyeon KIM, Daejeon (KR); Kang SAGONG, Daejeon (KR)

(21) Appl. No.: 19/097,869

(22) Filed: Apr. 2, 2025

(30) Foreign Application Priority Data
Apr. 3, 2024 (KR) 10-2024-0045395

(51) Int. Cl. H01M 50/383; H01M 50/211; H01M 50/289; H01M 50/358

(52) U.S. Cl. CPC H01M 50/383; H01M 50/211; H01M 50/289; H01M 50/358

(57) ABSTRACT

A battery pack includes a plurality of battery cells, a pack case forming a receiving space for receiving the plurality of battery cells, a first through-hole penetrating one surface of the pack case, a discharge portion located on the one surface of the pack case, and a first cyclone portion. The discharge portion includes a discharge body forming a discharge space therein, a discharge hole penetrating the discharge body to cause the discharge space to communicate with an outside, and a first body hole penetrating the discharge body. The first cyclone portion is connected to the pack case and the discharge portion and causes the receiving space to communicate with the discharge space via the first through-hole and the first body hole.

### CROSS-REFERENCE TO RELATED APPLICATION

The present application claims priority under 35 U.S.C. § 119(a) to Korean patent application number 10-2024-0045395, filed on Apr. 3, 2024, in the Korean Intellectual Property Office, the entire disclosure of which is incorporated herein by reference.

### BACKGROUND

### 1. Technical Field

Various embodiments of the present disclosure generally relate to a battery pack. More particularly, various embodiments of the present disclosure generally relate to a battery pack that improves the stability by suppressing or reducing the exposure of flame to the outside of the battery cell during thermal runaway.

### 2. Related Art

A secondary battery (or battery cell) can experience a rapid exothermic reaction due to an instantaneous high current when a cathode and an anode come into contact with each other due to an internal short circuit, external shock, or the like. This exothermic reaction can cause the temperature inside the battery cell to rise rapidly. This is called thermal runaway in the battery cell. When thermal runaway occurs in a battery cell, a case of the battery cell can open, releasing a hot fluid generated inside to the outside of the battery cell.

The fluid may include particles as well as a flammable gas. The particles may act as ignition particles for the gas. Accordingly, a device for capturing (or filtering) the particles or separating the particles from the fluid may be required to suppress or reduce ignition of the fluid due to the particles and the resulting flame.

### SUMMARY

One aspect of embodiments of the present disclosure is to improve the stability of a battery pack even when thermal runaway of a battery cell occurs.

Another aspect of embodiments of the present disclosure is to prevent or mitigate a fluid generated by thermal runaway of a battery cell from igniting due to particles and to prevent or mitigate flame due to the ignition from being exposed to the outside of the battery cell.

Another aspect of embodiments of the present disclosure is to separate and discharge particles and a fluid generated by thermal runaway of a battery cell when the fluid is discharged to the outside of a battery pack.

Another aspect of embodiments of the present disclosure is to efficiently capture particles during thermal runaway of a battery cell.

Another aspect of embodiments of the present disclosure is to reduce the amount of particles contained in a fluid generated by thermal runaway of a battery cell when the fluid is discharged to the outside of a battery pack.

A battery pack according to various embodiments of the present disclosure can be widely applied in the green technology fields such as electric vehicles, battery charging stations, and other technologies using batteries such as photovoltaics and wind power. Furthermore, the battery pack according to various embodiments of the present disclosure can be used in eco-friendly electric vehicles, hybrid vehicles, and the like to suppress or reduce air pollution and greenhouse gas emissions to prevent or mitigate climate change.

A battery pack according to embodiments of the present disclosure includes a plurality of battery cells, a pack case forming a receiving space for receiving the plurality of battery cells, a first through-hole penetrating one surface of the pack case, a discharge portion located on the one surface of the pack case, and a first cyclone portion. The discharge portion includes a discharge body forming a discharge space therein, a discharge hole penetrating the discharge body to cause the discharge space to communicate with an outside, and a first body hole penetrating the discharge body. The first cyclone portion is connected to the pack case and the discharge portion and causes the receiving space to communicate with the discharge space via the first through-hole and the first body hole.

According to an embodiment, the first cyclone portion may include a first cyclone space in communication with the receiving space and the discharge space; a first cyclone body forming the first cyclone space; a first inlet hole penetrating the first cyclone body at a position corresponding to the first through-hole; a first outlet hole penetrating the first cyclone body at a position corresponding to the first body hole; and a first insertion tube in a pipe shape, located closer to the first inlet hole than to the first outlet hole, and penetrating the first cyclone body such that one end of the first insertion tube is located in the first cyclone space.

According to an embodiment, a diameter of an inner circumferential surface of the first cyclone space may decrease in a direction toward the first outlet hole along an imaginary axis passing a center of the first outlet hole.

According to an embodiment, the one end of the first insertion tube may be located between the first inlet hole and the first outlet hole.

According to an embodiment, a mixing ratio of particles per unit volume of a fluid discharged to the discharge portion through the first outlet hole may be greater than or equal to a mixing ratio of particles per unit volume of a fluid discharged through the first insertion tube.

According to an embodiment, the first cyclone portion may further include a first connection member in a pipe shape connecting the first inlet hole and the first through-hole.

According to an embodiment, the first connection member may include flanges bent at at least one end of opposite ends of the first connection member and extending in a circumferential direction of the first connection member to be coupled to the first cyclone body or the pack case.

According to an embodiment, the first cyclone portion and the discharge body may extend in a direction parallel to a bottom surface of the pack case.

According to an embodiment, the discharge portion may include a first panel facing the one surface of the pack case and forming one surface of the discharge body; a second panel forming another surface of the discharge body which faces the first panel, and provided with the discharge hole; a first connection panel provided with the first body hole and connecting the first panel to the second panel; and a first partition portion provided parallel to the first connection panel, extending from one panel of the first panel and the second panel toward another panel, and spaced apart from the other panel.

According to an embodiment, the first partition portion may include a plurality of partitions. The plurality of partitions may include a first partition extending from the first panel toward the second panel and spaced apart from the second panel, and a second partition extending from the second panel toward the first panel and spaced apart from the first panel.

According to an embodiment, the discharge space may include a first space in communication with the first body hole and the discharge hole, and in which the first partition portion is arranged; and a second space located below the first space. The discharge portion may further include a separation portion located between the first space and the second space.

According to an embodiment, when a fluid generated in one of the plurality of battery cells moves from the receiving space through the first cyclone portion to the discharge portion, one or more of the particles mixed in the fluid may be captured on a bottom surface of the discharge space by their own weight.

According to an embodiment, the battery pack may further include a second through-hole penetrating the one surface of the pack case; and a second cyclone portion connected to the pack case and the discharge portion and causing the receiving space to communicate with the discharge space through the second through-hole and a second body hole which penetrates the discharge body to face the first body hole.

According to an embodiment, the second cyclone portion may include a second cyclone space in communication with the receiving space and the discharge space; a second cyclone body forming the second cyclone space; a second inlet hole penetrating the second cyclone body at a position corresponding to the second through-hole; a second outlet hole penetrating the second cyclone body at a position corresponding to the second body hole; and a second insertion tube in a pipe shape, located closer to the second inlet hole than to the second outlet hole, and penetrating the second cyclone body such that one end of the second insertion tube is located in the second cyclone space.

According to an embodiment, a diameter of an inner circumferential surface of the second cyclone space may decrease in a direction toward the second outlet hole along an imaginary axis passing a center of the second outlet hole.

According to an embodiment, the one end of the second insertion tube may be located between the second inlet hole and the second outlet hole.

According to an embodiment, the first cyclone portion may further include a first connection member in a pipe shape connecting the first inlet hole and the first through-hole. The second cyclone portion may further include a second connection member in a pipe shape connecting the second inlet hole and the second through-hole.

According to an embodiment, the discharge portion may include a first panel facing the one surface of the pack case and forming one surface of the discharge body; a second panel forming another surface of the discharge body which faces the first panel, and provided with the discharge hole; a first connection panel provided with the first body hole and connecting the first panel and the second panel; a second connection panel provided with the second body hole and connecting the first panel and the second panel; a first partition portion located closer to the first connection panel than to the second connection panel, extending from one panel of the first panel and the second panel toward another panel, and spaced apart from the other panel; and a second partition portion located closer to the second connection panel than to the first connection panel, extending from one panel of the first panel and the second panel toward another panel, and spaced apart from the other panel.

According to an embodiment, each of the first partition portion and the second partition portion may include a plurality of partitions. The plurality of partitions may include a first partition extending from the first panel toward the second panel and spaced apart from the second panel, and a second partition extending from the second panel toward the first panel and spaced apart from the first panel.

### BRIEF DESCRIPTION OF THE DRAWINGS

FIG. 1 is a diagram illustrating an example of a battery pack according to an embodiment of the present disclosure;

FIG. 2 is a plan view of an example of a battery pack according to an embodiment of the present disclosure;

FIG. 3 is an exploded view of an example of a processing unit according to an embodiment of the present disclosure;

FIG. 4 is a schematic diagram illustrating directions of travel of particles and a fluid in an example of a processing unit according to an embodiment of the present disclosure;

FIG. 5 is a front view of an example of a processing unit according to an embodiment of the present disclosure;

FIG. 6 is a front view of another example of a processing unit according to an embodiment of the present disclosure;

FIG. 7A is a diagram illustrating an example of a discharge portion according to an embodiment of the present disclosure. FIG. 7B is a diagram illustrating another example of a discharge portion according to an embodiment of the present disclosure; and

FIG. 8 is a diagram illustrating another example of a battery pack according to an embodiment of the present disclosure.

### DETAILED DESCRIPTION

Hereinafter, embodiments are described with reference to the accompanying drawings. However, the present disclosure is not limited to any particular embodiment nor to any specific details. Also, in embodiments of the present disclosure, the terms battery, secondary battery, and cell all equally refer to a battery cell that is capable of being charged and discharged.

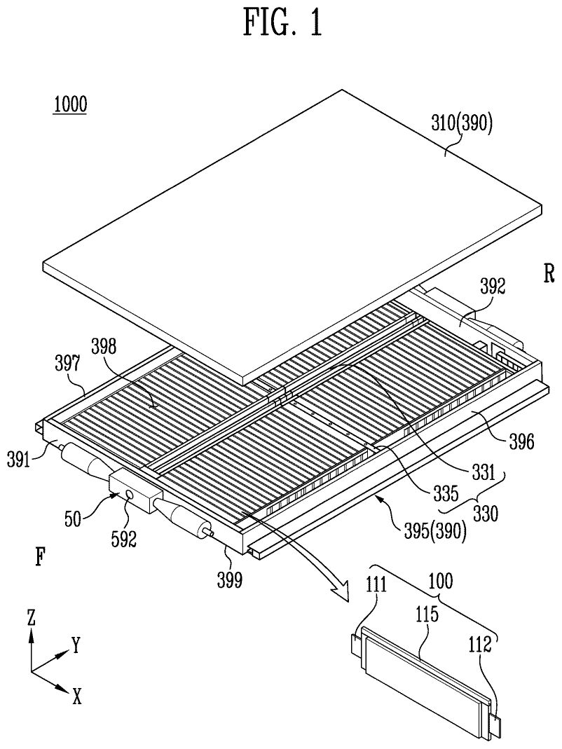

FIG. 1 is a diagram illustrating an example of a battery pack 1000 according to an embodiment of the present disclosure.

Referring to FIG. 1, the battery pack 1000 according to an embodiment of the present disclosure may include a plurality of battery cells 100, a pack case 390 receiving the plurality of battery cells 100, and a processing unit 50 coupled to one surface of the pack case 390 so as to be able to communicate with the inside of the pack case 390.

The battery cell 100 may include a body portion 115 having an electrode assembly (not shown) that produces or stores electrical energy therein, and lead tab portions 111 and 112 that protrude outwardly from the body portion 115 in electrical connection with the electrode assembly.

Referring to FIG. 1, the battery cell 100 is illustrated as a pouch-shaped battery cell, but the shape of the battery cell 100 is not limited to the pouch-shaped battery cell 100 as described herein. That is, the battery pack 1000 according to an embodiment of the present disclosure may include a square or cylindrical battery cell 100.

Referring to FIG. 1, the battery pack 1000 according to an embodiment of the present disclosure can receive the plurality of battery cells 100 in a receiving space 398. The plurality of battery cells 100 may be stacked in a predetermined stacking direction.

Although FIG. 1 illustrates an example where the plurality of battery cells 100 are stacked in a Y direction, the plurality of battery cells 100 may be stacked in another direction.

The pack case 390 may include a receiving cover 310 and a receiving body 395 that together form the receiving space 398. Referring to FIG. 1, the receiving body 395 may be open on one surface. The receiving cover 310 may be coupled to the receiving body 395 to cover the open one surface.

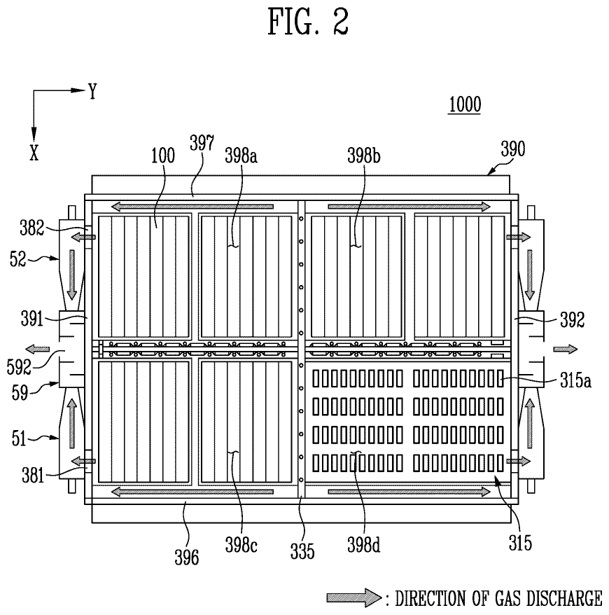

Further, the pack case 390 may include a compartment portion 330 for compartmentalizing the receiving space 398 into a plurality of subspaces 398a to 398d (see FIG. 2). The compartment portion 330 may include a first frame 331 extending in the Y direction and a second frame 335 extending in an X direction in the receiving space 398.

In other words, the compartment portion 330 may compartmentalize the receiving space 398 into the plurality of subspaces 398a to 398d in two directions perpendicular to the height direction of the pack case 390 and each perpendicular to the other.

FIG. 1 illustrates an example where the plurality of battery cells 100 are grouped in a predetermined number and arranged in two columns in the Y direction. Additionally, the plurality of battery cells 100 may also be arranged in two rows in the X direction. However, the example shown in FIG. 1 is an example only, and the number of the plurality of subspaces 398a to 398d can be varied, and the number of rows and columns can be varied accordingly.

The pack case 390 may include a bottom surface 399 supporting the plurality of battery cells 100, and pack side surfaces 391, 392, 396, and 397 extending from corners of the bottom surface 399, respectively, toward the receiving cover 310 to form side surfaces of the pack case 390.

As used herein, one surface of the pack case 390 may refer to one of the pack side surfaces 391, 392, 396, and 397, the bottom surface 399, or the receiving cover 310.

The front and the rear of the battery pack 1000 according to an embodiment of the present disclosure are not limited to the front and the rear shown in the drawings, as the front (F) and the rear (R) are defined herein for purposes of description and understanding only.

The battery pack 1000 according to an embodiment of the present disclosure may include the processing unit 50 coupled to the pack case 390 so as to be able to communicate with the pack case 390.

The processing unit 50 may be coupled to one surface of the pack case 390 to communicate with the receiving space 398. A fluid generated in at least one battery cell 100 of the plurality of battery cells 100 may be discharged to the outside of the battery pack 1000 through the processing unit 50. To discharge the fluid, the processing unit 50 may be provided with a discharge hole 592 causing the receiving space 398 to communicate with the outside.

Further, the processing unit 50 may further include a protective cover (not shown) covering the discharge hole 592.

The protective cover may be detached from the discharge hole 592 when the pressure in the receiving space 398 reaches a predetermined allowable pressure.

When a cathode and an anode of the battery cell 100 inadvertently come into contact with each other inside the battery cell 100, the temperature inside the battery cell 100 may increase rapidly, causing thermal runaway. When the battery cell 100 expands due to thermal runaway, the case of the battery cell 100 may be open or tear, releasing a fluid inside, particles mixed in the fluid, and/or flame into the receiving space 398.

When thermal runaway of the battery cell 100 begins to spread to adjacent battery cells 100, the temperature and pressure of the receiving space 398 may increase. Considering the safety of the user, it is necessary to quickly discharge the fluid and/or the particles in the receiving space 398 caused by thermal runaway to the outside. To discharge the fluid and/or the particles, the protective cover may tear or burst when the pressure in the receiving space 398 is above the allowable pressure, i.e., the protective cover may detach from the discharge hole 592 above the allowable pressure and communicate the receiving space 398 with the outside via the processing unit 50. Thus, the fluid and/or the particles in the receiving space 398 may be discharged past the processing unit 50 to the outside.

In order for the protective cover to detach from the discharge hole 592 above the allowable pressure, the material of the protective cover and the material of the discharge hole 592 may be different. For example, the protective cover may include a polymeric material, whereas the discharge hole 592 may include metal.

FIG. 2 is a plan view of an example of the battery pack 1000 according to an embodiment of the present disclosure.

Referring to FIGS. 1 and 2, the battery pack 1000 according to an embodiment of the present disclosure may include the plurality of battery cells 100, the pack case 390 forming the receiving space 398 (see FIG. 1) for receiving the plurality of battery cells 100, a first through-hole 381 penetrating one surface of the pack case 390, and the processing unit 50 coupled to one surface of the pack case 390 and causing the receiving space 398 connected to the first through-hole 381 to communicate with the outside.

More specifically, the pack case 390 may be provided with the first through-hole 381 penetrating one surface of the pack case 390. The inside of the receiving space 398 and the inside of the processing unit 50 may be in communication with each other through the first through-hole 381. Referring to FIG. 2, one surface of the pack case 390 may be one of the pack side surfaces 391, 392, 396, and 397 (see FIG. 1) or the bottom surface 399 (see FIG. 1) of the pack case 390. Preferably, one surface of the pack case 390 may be a pack front surface 391 and/or a pack rear surface 392 of the pack side surfaces 391, 392, 396, and 397.

Referring to FIG. 2, the plurality of battery cells 100 may be divided and received in the plurality of subspaces 398a to 398d. Referring to FIG. 2, the battery pack 1000 may include a subcover 315 covering each of the subspaces 398a to 398d.

Further, the subcover 315 may be provided with a subcover through-hole 315a penetrating the subcover 315.

Referring to FIG. 2, a fluid and/or particles generated in one of the battery cells 100 may travel in the X direction towards the pack side surface 396 or 397. Because a busbar (not shown) electrically connecting the plurality of battery cells 100 to the outside is located at the center of the battery pack 1000, there may be relatively little space for the fluid to pass through.

That is, the fluid and/or the particles generated in one of the battery cells 100 may travel in the X direction toward a first pack side surface 396 and/or a second pack side surface 397 of the battery pack 1000, and then toward the processing unit 50 or another pack side surface such as the pack front surface 391 and/or the pack rear surface 392 located at the front and/or the rear of the battery pack 1000.

At the first pack side surface 396 and/or the second pack side surface 397, the fluid and/or the particles may move through an empty space between the first pack side surface 396 and/or the second pack side surface 397 and the plurality of battery cells 100. Alternatively, the battery pack 1000 may further include a tunnel-shaped frame (not shown) to allow the fluid to move inwardly along the first pack side surface 396 and/or the second pack side surface 397.

The fluid and/or the particles arriving adjacent to the processing unit 50 in the receiving space 398 may enter the processing unit 50 through the first through-hole 381.

The pack case 390 may be further provided with a second through-hole 382 penetrating the pack case 390. The second through-hole 382 may be located at the same surface of the pack case 390 as the first through-hole 381.

Referring to FIG. 2, the first through-hole 381 and the second through-hole 382 may be formed at the pack front surface 391. Furthermore, a through-hole of the same shape may be located at the pack rear surface 392, and the same processing unit 50 as the processing unit 50 connected to the first through-hole 381 and the second through-hole 382 may be coupled to the pack rear surface 392.

The number of the through-holes and the number of the processing units 50 may be varied.

The processing unit 50 may include a first cyclone portion 51 coupled to one surface of the pack case 390 to be connected to the first through-hole 381 and a discharge portion 59 connected to the first cyclone portion 51.

Further, the processing unit 50 may include a second cyclone portion 52 coupled to one surface of the pack case 390 to be connected to the second through-hole 382. The second cyclone portion 52 may be connected to one surface of the pack case 390 and to the discharge portion 59.

The discharge portion 59 may be located between the first cyclone portion 51 and the second cyclone portion 52. Accordingly, the discharge portion 59 may discharge the fluid and/or the particles traveling through the first through-hole 381 and the first cyclone portion 51, and the fluid and/or the particles traveling through the second through-hole 382 and the second cyclone portion 52, to the outside through the discharge hole 592 penetrating one surface of the discharge portion 59.

The first cyclone portion 51 may be connected to the first through-hole 381. The first cyclone portion 51 may separate the particles using centrifugal force from the fluid and/or the particles introduced through the first through-hole 381.

Similarly, the second cyclone portion 52 may be connected to the second through-hole 382. The second cyclone portion 52 may separate the particles using centrifugal force from the fluid and/or the particles introduced through the second through-hole 382.

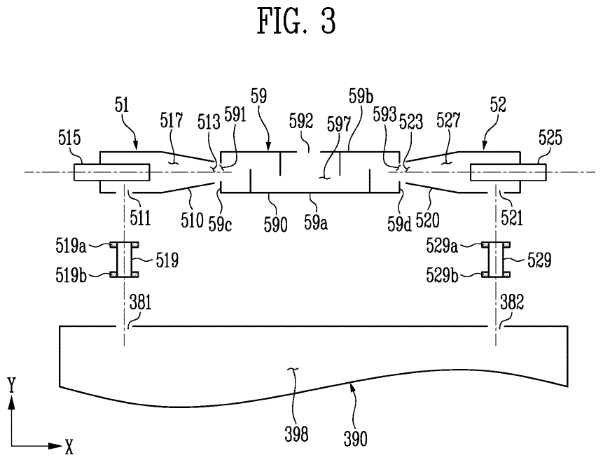

FIG. 3 is an exploded view of an example of the processing unit 50 according to an embodiment of the present disclosure.

Referring to FIGS. 1 to 3, the battery pack 1000 according to an embodiment of the present disclosure may include the plurality of battery cells 100, the pack case 390 forming the receiving space 398 (see FIG. 1) for receiving the plurality of battery cells 100, the first through-hole 381 penetrating one surface of the pack case 390, the discharge portion 59 which is located on one surface of the pack case 390 and which includes a discharge body 590 forming a discharge space 597 therein, the discharge hole 592 penetrating the discharge body 590 to cause the discharge space 597 to communicate with the outside, and a first body hole 591 penetrating the discharge body 590, and the first cyclone portion 51 connected to the pack case 390 and the discharge portion 59 and causing the receiving space 398 to communicate with the discharge space 597 via the first through-hole 381 and the first body hole 591.

Referring to FIG. 3, the battery pack 1000 according to an embodiment of the present disclosure may include the pack case 390 receiving the plurality of battery cells and the processing unit 50 coupled to one surface of the pack case 390.

The processing unit 50 may include the discharge portion 59 and the first cyclone portion 51.

Also, the processing unit 50 may further include the second cyclone portion 52.

FIG. 3 illustrates the first through-hole 381 and the second through-hole 382 formed at the pack front surface 391. Further, FIG. 3 shows the processing unit 50 connected to the first through-hole 381 and the second through-hole 382. However, as described above, the processing unit 50 may also be located at the pack rear surface 392.

Referring to FIG. 3, the first cyclone portion 51 may include a first cyclone space 517 in communication with the receiving space 398 and the discharge space 597, a first cyclone body 510 forming the first cyclone space 517, a first inlet hole 511 penetrating the first cyclone body 510 at a position corresponding to the first through-hole 381, a first outlet hole 513 penetrating the first cyclone body 510 at a position corresponding to the first body hole 591, and a first insertion tube 515 in the shape of a pipe, located closer to the first inlet hole 511 than to the first outlet hole 513, and penetrating the first cyclone body 510 such that one end of the first insertion tube 515 is located in the first cyclone space 517.

The first cyclone portion 51 is a device for separating a fluid and particles from a mixture of the fluid and the particles using centrifugal force, i.e., by rotating the fluid and the particles entering the inside of the first cyclone portion 51, the fluid and the particles can be separated from each other due to the weight difference between the fluid and the particles.

The first cyclone body 510 may form the first cyclone space 517 therein. The first cyclone body 510 may include the first inlet hole 511 penetrating the first cyclone body 510 to cause the receiving space 398 to communicate with the first cyclone space 517.

The first cyclone body 510 may further include the first outlet hole 513 penetrating the first cyclone body 510 to cause the discharge space 597 to communicate with the first cyclone space 517.

For separation of the fluid and the particles, the first cyclone body 510 may have a shape in which a cross-section of the first cyclone space 517 has the area decreasing in the direction away from the first inlet hole 511 toward the first outlet hole 513. For example, the first cyclone body 510 may have a cone or truncated cone shape.

The first inlet hole 511 may be connected to the first through-hole 381, and the first outlet hole 513 may be connected to the first body hole 591. Thus, the receiving space 398, the first cyclone space 517, the discharge space 597, and the outside may communicate with each other.

The fluid and the particles entering the first cyclone space 517 through the first inlet hole 511 can spiral along the inner circumferential surface of the first cyclone space 517, thereby allowing most of the particles, along with some of the fluid, to travel to the discharge portion 59 through the first outlet hole 513.

On the other hand, the fluid separated from the particles may be discharged to the outside through the first insertion tube 515, i.e., the first insertion tube 515 may be in the shape of a pipe with opposite ends open. The first insertion tube 515 may penetrate the first cyclone body 510.

Accordingly, one end of the first insertion tube 515 may be located in the first cyclone body 510.

More specifically, one end of the first insertion tube 515 may be located between the first inlet hole 511 and the first outlet hole 513 so as to prevent or reduce the fluid and the particles introduced through the first inlet hole 511 from being discharged through the first insertion tube 515 without separation.

The first cyclone space 517 may be narrower in the direction toward the discharge portion 59 in accordance with the shape of the first cyclone body 510. The diameter of the inner circumferential surface of the first cyclone space 517 may decrease in the direction toward the first outlet hole 513 along an imaginary axis passing the center of the first outlet hole 513.

Accordingly, the fluid can turn and move toward the first insertion tube 515. On the other hand, the particles may move along the inner circumferential surface of the first cyclone space 517 to the discharge portion 59 through the first outlet hole 513 and the first body hole 591.

The first cyclone portion 51 may further include a first connection member 519 in the shape of a pipe connecting the first inlet hole 511 and the first through-hole 381. Via the first connection member 519, the first cyclone portion 51 may be coupled to the pack case 390.

The first connection member 519 may include flanges 519a and 519b that are bent at at least one of opposite ends of the first connection member 519 and extend in a circumferential direction of the first connection member 519 to be coupled to the first cyclone body 510, or the pack case 390.

Referring to FIG. 3, the first cyclone portion 51 and the discharge body 590 may extend in a direction parallel to one of the bottom surface 399 (see FIG. 1), the pack front surface 391, or the pack rear surface 392 of the pack case.

Further, the battery pack 1000 according to an embodiment of the present disclosure may be provided with the second through-hole 382 penetrating one surface of the pack case 390, and may include the second cyclone portion 52 connected to the pack case 390 and the discharge portion 59 and causing the receiving space 398 to communicate with the discharge space 597 through the second through-hole 382 and a second body hole 593 which penetrates the discharge body 590 to face the first body hole 591.

In other words, the battery pack 1000 may include the first cyclone portion 51 and the second cyclone portion 52 with the discharge portion 59 interposed between the first and second cyclone portions 51 and 52 on the outer side of the pack case 390.

The first through-hole 381 and the second through-hole 382 may be formed on the same surface of the surfaces of the pack case 390 so as to allow rapid discharge of the fluid or the particles from the receiving space 398. The first through-hole 381 and the second through-hole 382 may be formed on the same surface of the surfaces of the pack case 390 so as to discharge the fluid or the particles from the respective subspaces 398a to 398d (see FIG. 2) through the first through-hole 381 and the second through-hole 382 independently of each other.

Referring to FIG. 3, one discharge portion 59 is provided, while the first cyclone portion 51 and the second cyclone portion 52 are arranged at opposite sides of the discharge portion 59, respectively. Alternatively, the discharge portion 59 may include a first discharge portion (not shown) connected to the first cyclone portion 51 and a second discharge portion (not shown) connected to the second cyclone portion 52. The first discharge portion and the second discharge portion may be provided with a first discharge hole (not shown) and a second discharge hole (not shown) for discharging a fluid and gas to the outside, respectively.

Referring to FIG. 3, similarly to the first cyclone portion 51, the second cyclone portion 52 may include a second cyclone space 527 in communication with the receiving space 398 and the discharge space 597, a second cyclone body 520 forming the second cyclone space 527, a second inlet hole 521 penetrating the second cyclone body 520 at a position corresponding to the second through-hole 382, a second outlet hole 523 penetrating the second cyclone body 520 at a position corresponding to the second body hole 593, and a second insertion tube 525 in the shape of a pipe, located closer to the second inlet hole 521 than to the second outlet hole 523, and penetrating the second cyclone body 520 such that one end of the second insertion tube 525 is located in the second cyclone space 527.

Further, similarly to the first cyclone space 517, the diameter of the inner circumferential surface of the second cyclone space 527 may decrease in the direction toward the second outlet hole 523 along an imaginary axis passing the center of the second outlet hole 523.

For separation of the fluid and the particles, the second cyclone body 520 may have a shape in which a cross-section of the second cyclone space 527 has the area decreasing in the direction away from the second inlet hole 521 toward the second outlet hole 523. For example, the second cyclone body 520 may have a cone or truncated cone shape.

Similarly to the first insertion tube 515, one end of the second insertion tube 525 may be located between the second inlet hole 521 and the second outlet hole 523.

In addition, the second cyclone portion 52 may further include a second connection member 529 in the shape of a pipe connecting the second inlet hole 521 and the second through-hole 382.

The second connection member 529 may include flanges 529a and 529b that are bent at at least one of opposite ends of the second connection member 529 and extend in a circumferential direction of the second connection member 529 to be coupled to the second cyclone body 520, or the pack case 390.

Because the detailed descriptions of the second cyclone portion 52 are the same as those of the first cyclone portion 51 as set forth above, and thus are omitted.

The discharge portion 59 may include the discharge body 590 forming the discharge space 597 therein, the first body hole 591 penetrating the discharge body 590, and the discharge hole 592 penetrating the discharge body 590 to cause the discharge space 597 to communicate with the outside.

The first body hole 591 may be formed at a position corresponding to the first outlet hole 513 on one surface of the surfaces of the discharge body 590 which faces the first cyclone portion 51. Thus, when the first cyclone portion 51 is coupled to the discharge portion 59, the first cyclone space 517 may communicate with the discharge space 597 via the first body hole 591 and the first outlet hole 513.

Furthermore, the discharge hole 592 may be formed on another surface of the surfaces of the discharge body 590. The discharge hole 592 is formed on another surface of the discharge body 590 such that after the fluid and the particles travel through the discharge space 597 via the first body hole 591, most of the particles settle to the bottom surface of the discharge body 590, and only a portion of the particles and the fluid are discharged to the outside through the discharge hole 592.

That is, when a fluid generated in one of the plurality of battery cells 100 moves from the receiving space 398 through the first cyclone portion 51 to the discharge portion 59, at least one or more of particles mixed in the fluid may be captured on the bottom surface of the discharge space 597 by their own weight.

The discharge body 590 may include a first panel 59a facing one surface of the pack case 390 and forming one surface of the discharge body 590, a second panel 59b forming another surface of the discharge body 590 which faces the first panel 59a, and provided with the discharge hole 592, and a first connection panel 59c provided with the first body hole 591 and connecting the first panel 59a to the second panel 59b.

In addition, the discharge body 590 may further include a second connection panel 59d provided with the second body hole 593 and connecting the first panel 59a to the second panel 59b.

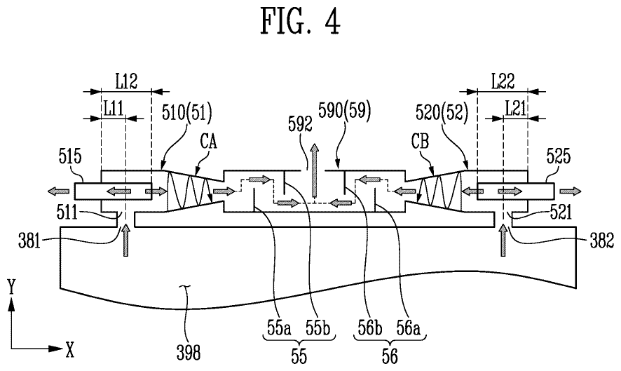

FIG. 4 is a schematic diagram illustrating directions of travel of particles and a fluid in an example of the processing unit 50 according to an embodiment of the present disclosure.

A fluid and particles generated in the receiving space 398 may travel through the first through-hole 381 and the first inlet hole 511 to the first cyclone portion 51 which is coupled to the pack case 390.

The particles and the fluid travelling into the first cyclone body 510 via the first inlet hole 511 may be separated from each other via helical motion inside the first cyclone body 510. The particles may move to the discharge portion 59, and the fluid separated from the particles may be discharged to the outside through the first insertion tube 515.

That is, the mixing ratio of particles per unit volume of the fluid discharged to the discharge portion 59 through the first outlet hole 513 (see FIG. 3) may be greater than or equal to the mixing ratio of particles per unit volume of the fluid discharged through the first insertion tube 515.

As mentioned above, one end of the first insertion tube 515 may be located between the first inlet hole 511 and the first outlet hole 513. Referring to FIG. 4, a length L12 to one end, which is located in the first cyclone space 517, of opposite ends of the first insertion tube 515 relative to one surface of the first cyclone body 510 may be greater than a length L11 to the center of the first inlet hole 511.

Similarly, the fluid and the particles generated in the receiving space 398 can travel through the second through-hole 382 and the second inlet hole 521 to the second cyclone portion 52 which is coupled to the pack case 390.

The particles and the fluid travelling into the second cyclone body 520 via the second inlet hole 521 may be separated from each other via helical motion inside the second cyclone body 520. The particles may move to the discharge portion 59, and the fluid separated from the particles may be discharged to the outside via the second insertion tube 525.

That is, the mixing ratio of particles per unit volume of the fluid discharged to the discharge portion 59 via the second outlet hole 523 (see FIG. 3) may be greater than or equal to the mixing ratio of particles per unit volume of the fluid discharged via the second insertion tube 525.

As mentioned above, one end of the second insertion tube 525 may be located between the second inlet hole 521 and the second outlet hole 523. Referring to FIG. 4, a length L22 to one end, which is located in the second cyclone space 527, of opposite ends of the second insertion tube 525 relative to one surface of the second cyclone body 520 may be greater than a length L21 to the center of the second inlet hole 521.

Referring to FIG. 4, the discharge portion 59 may include a first partition portion 55 in the discharge body 590 to extend the distance that the fluid and the particles introduced through the first body hole 591 travel through the discharge hole 592.

Furthermore, the discharge portion 59 may include a second partition portion 56 in the discharge body 590 to extend the distance that the fluid and the particles introduced through the second body hole 593 travel through the discharge hole 592.

In the discharge space 597, the fluid may move in a zigzag or meander line pattern due to the first partition portion 55 and the second partition portion 56.

Referring to FIG. 4, the discharge portion 59 may include the first panel 59a facing one surface of the pack case 390 and forming one surface of the discharge body 590, the second panel 59b forming another surface of the discharge body 590 which faces the first panel 59a, and including the discharge hole 592, the first connection panel 59c provided with the first body hole 591 and connecting the first panel 59a and the second panel 59b, and the first partition portion 55 provided parallel to the first connection panel 59c, extending from either the first panel 59a or the second panel 59b toward the other panel, and spaced apart from the other panel.

Also, referring to FIG. 4, the first partition portion 55 may include a plurality of partitions 55a and 55b, and the plurality of partitions 55a and 55b may include a first partition 55a extending from the first panel 59a toward the second panel 59b and spaced apart from the second panel 59b, and a second partition 55b extending from the second panel 59b toward the first panel 59a and spaced apart from the first panel 59a.

In addition, the discharge portion 59 may further include the first panel 59a facing one surface of the pack case 390 and forming one surface of the discharge body 590, the second panel 59b forming another surface of the discharge body 590 which faces the first panel 59a, and including the discharge hole 592, the first connection panel 59c provided with the first body hole 591 and connecting the first panel 59a and the second panel 59b, the second connection panel 59d provided with the second body hole 593 and connecting the first panel 59a and the second panel 59b, and the second partition portion 56 located closer to the second connection panel 59d than to the first connection panel 59c, extending from either the first panel 59a or the second panel 59b toward the other panel, and spaced apart from the other panel.

Similarly to the first partition portion 55, the second partition portion 56 may include a plurality of partitions 56a and 56b, and the plurality of partitions 56a and 56b may include a first partition 56a extending from the first panel 59a toward the second panel 59b and spaced apart from the second panel 59b, and a second partition 56b extending from the second panel 59b toward the first panel 59a and spaced apart from the first panel 59a.

The particles traveling with the fluid may move in a zigzag pattern due to the first partition portion 55 and the second partition portion 56 and settle on the bottom surface of the discharge body 590 by their own weight.

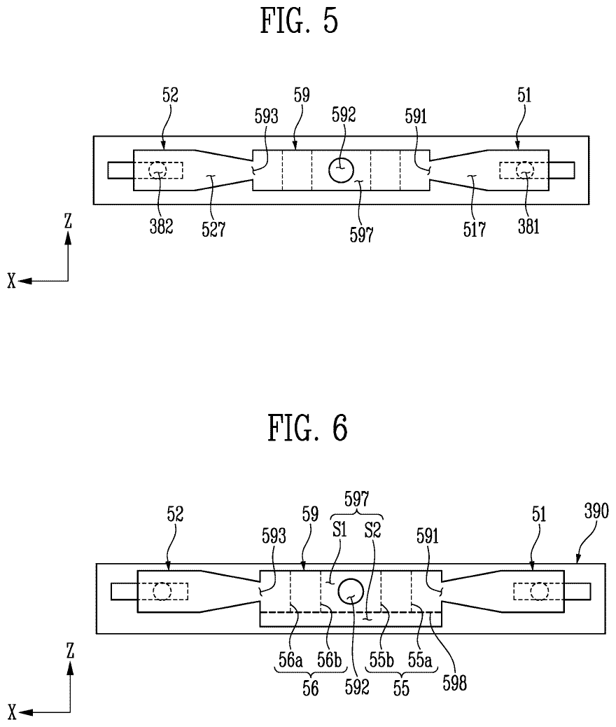

FIG. 5 is a front view of an example of the processing unit 50 according to an embodiment of the present disclosure.

Referring to FIG. 5, the first cyclone portion 51 and the second cyclone portion 52 may be arranged with the discharge portion 59 interposed therebetween. Similarly, the discharge hole 592 may be positioned between the first through-hole 381 and the second through-hole 382.

Further, the first cyclone space 517 and the second cyclone space 527 may be in communication with the discharge space 597 via the first body hole 591 and the second body hole 593.

The discharge hole 592 is located between the first body hole 591 and the second body hole 593, and preferably, the distance from the discharge hole 592 to the first body hole 591 may be the same as the distance from the discharge hole 592 to the second body hole 593.

FIG. 6 is a front view of another example of the processing unit 50 according to an embodiment of the present disclosure.

Unlike the example shown in FIG. 5, the discharge portion 59 may include the discharge space 597 separated by a separation portion 598.

In other words, the discharge space 597 may include a first space S1 in communication with the first body hole 591 and the discharge hole 592, and in which the first partition portion 55 is arranged, and a second space S2 located below the first space S1, and the discharge portion 59 may further include the separation portion 598 located between the first space S1 and the second space S2.

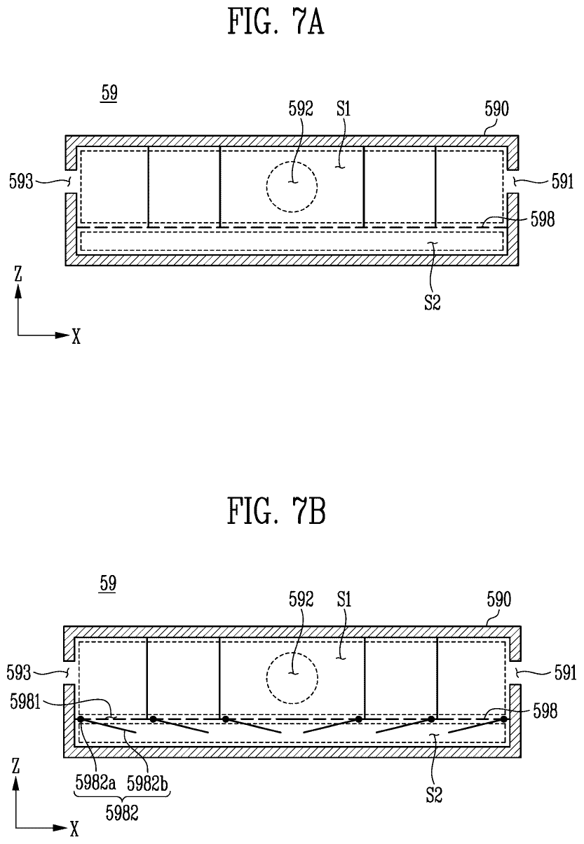

The separation portion 598 is a panel located between the first space S1 and the second space S2, and may be provided with a capture hole 5981 (see FIG. 7B) for causing the first space S1 to communicate with the second space S2.

The first space S1 may be a space in which the fluid and the particles entering the discharge body 590 via the first body hole 591 and/or the second body hole 593 travel, and the second space S2 may be a space in which the particles are separated from the fluid by their own weight during travel and captured.

Specifically, when a fluid generated in one of the plurality of battery cells 100 moves from the receiving space 398 through the first cyclone portion 51 to the discharge portion 59, one or more of the particles mixed in the fluid may be captured on the bottom surface of the discharge space 597 by their own weight. Specifically, one or more of the particles mixed in the fluid may move from the first space S1 to the second space S2 by their own weight and may be captured on the bottom surface of the second space S2.

Similarly, when the fluid generated in one of the plurality of battery cells 100 moves from the receiving space 398 through the second cyclone portion 52 to the discharge portion 59, one or more of the particles mixed in the fluid may be captured on the bottom surface of the discharge space 597 by their own weight. Specifically, one or more of the particles mixed in the fluid may move from the first space S1 to the second space S2 by their own weight and may be captured on the bottom surface of the second space S2.

FIG. 7A illustrates an example of the discharge portion 59 according to an embodiment of the present disclosure. FIG. 7B illustrates another example of the discharge portion 59 according to an embodiment of the present disclosure.

Referring to FIG. 7A, the discharge portion 59 may include the separation portion 598 located between the first space S1 and the second space S2. Further, the separation portion 598 may be provided with a plurality of capture holes 5981 (see FIG. 7B). Further, the separation portion 598 may be provided in a mesh shape to separate the first space S1 from the second space S2 so as to be able to communicate with each other.

Referring to FIG. 7B, the discharge portion 59 may include the separation portion 598 positioned between the first space S1 and the second space S2. Further, the separation portion 598 may be provided with the plurality of capture holes 5981 and an opening and closing portion 5982 hingedly coupled to the separation portion 598 for opening and closing the capture holes 5981. The opening and closing portion 5982 may include a hinge shaft 5982a and a door 5982b rotatably coupled about the hinge shaft 5982a.

The hinge shaft 5982a may extend in a direction from the first body hole 591 toward the second body hole 593 and in a direction perpendicular to the height direction of the discharge portion 59. For example, the hinge shaft 5982a may extend in a front-to-rear direction of the pack case 390 (see FIG. 1).

Furthermore, between the first body hole 591 and the discharge hole 592, the hinge shaft 5982a may be coupled to the separation portion 598 such that the door 5982b slopes downwardly toward the discharge hole 592 upon opening of the door 5982b. Between the second body hole 593 and the discharge hole 592, the hinge shaft 5982a may be coupled to the separation portion 598 such that the door 5982b slopes downwardly toward the discharge hole 592 upon opening of the door 5982b.

Accordingly, the door 5982b located between the first body hole 591 and the discharge hole 592 may open in the opposite direction to the door 5982b located between the second body hole 593 and the discharge hole 592.

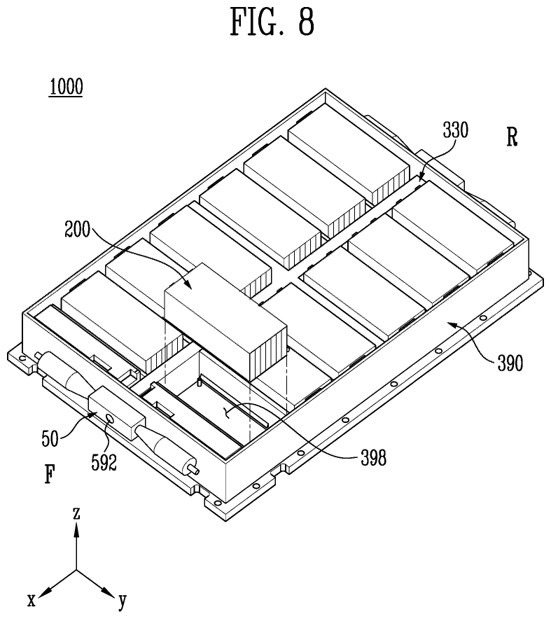

FIG. 8 is a diagram illustrating another example of the battery pack 1000 according to an embodiment of the present disclosure.

Referring to FIG. 8, the battery pack 1000 according to another example of the present disclosure may include a battery module 200 including battery cells 100 grouped in a predetermined number, and the battery module 200 may be received in the receiving space 398. The receiving space 398 may be compartmentalized into a plurality of subspaces by the compartment portion 330.

Similarly, the battery pack 1000 according to another example of the present disclosure may include the pack case 390 including the receiving cover 310 (see FIG. 1) and the receiving body 395, and the processing unit 50 coupled to the pack case 390 so as to be able to communicate with the pack case 390. Because the descriptions of the processing unit 50 are the same as those set forth above, and thus are omitted.

The descriptions as provided above are merely examples of the application of the principles of the present disclosure, and other configurations may be further included without departing from the scope of the present disclosure.

According to some embodiments of the present disclosure, the stability of a battery pack can be improved even when thermal runaway of a battery cell occurs.

According to some embodiments of the present disclosure, a fluid generated by thermal runaway of a battery cell can be prevented or mitigated from igniting due to particles and flame due to the ignition can be prevented or mitigated from being exposed to the outside of the battery cell.

According to some embodiments of the present disclosure, when the fluid is discharged to the outside of a battery pack, particles and a fluid generated by thermal runaway of a battery cell can be separated and discharged.

According to some embodiments of the present disclosure, particles can be efficiently captured during thermal runaway of a battery cell.

According to some embodiments of the present disclosure, the amount of particles contained in a fluid generated by thermal runaway of a battery cell can be reduced when the fluid is discharged to the outside of a battery pack.

What is claimed is:

1. A battery pack, comprising:
a plurality of battery cells;
a pack case forming a receiving space for receiving the plurality of battery cells;
a first through-hole penetrating one surface of the pack case;
a discharge portion located on the one surface of the pack case, wherein the discharge portion includes:
a discharge body forming a discharge space therein;
a discharge hole penetrating the discharge body to cause the discharge space to communicate with an outside; and
a first body hole penetrating the discharge body; and
a first cyclone portion connected to the pack case and the discharge portion and causing the receiving space to communicate with the discharge space via the first through-hole and the first body hole.

2. The battery pack of claim 1, wherein the first cyclone portion includes:
a first cyclone space in communication with the receiving space and the discharge space;
a first cyclone body forming the first cyclone space;
a first inlet hole penetrating the first cyclone body at a position corresponding to the first through-hole;
a first outlet hole penetrating the first cyclone body at a position corresponding to the first body hole; and
a first insertion tube in a pipe shape, located closer to the first inlet hole than to the first outlet hole, and penetrating the first cyclone body such that one end of the first insertion tube is located in the first cyclone space.

3. The battery pack of claim 2, wherein a diameter of an inner circumferential surface of the first cyclone space decreases in a direction toward the first outlet hole along an imaginary axis passing a center of the first outlet hole.

4. The battery pack of claim 2, wherein the one end of the first insertion tube is located between the first inlet hole and the first outlet hole.

5. The battery pack of claim 2, wherein a mixing ratio of particles per unit volume of a fluid discharged to the discharge portion through the first outlet hole is greater than or equal to a mixing ratio of particles per unit volume of a fluid discharged through the first insertion tube.

6. The battery pack of claim 2, wherein the first cyclone portion further includes a first connection member in a pipe shape connecting the first inlet hole and the first through-hole.

7. The battery pack of claim 6, wherein the first connection member includes flanges bent at at least one end of opposite ends of the first connection member and extending in a circumferential direction of the first connection member to be coupled to the first cyclone body or the pack case.

8. The battery pack of claim 1, wherein the first cyclone portion and the discharge body extend in a direction parallel to a bottom surface of the pack case.

9. The battery pack of claim 1, wherein the discharge portion includes:
a first panel facing the one surface of the pack case and forming one surface of the discharge body;
a second panel forming another surface of the discharge body which faces the first panel, and provided with the discharge hole;
a first connection panel provided with the first body hole and connecting the first panel to the second panel; and
a first partition portion provided parallel to the first connection panel, extending from one panel of the first panel and the second panel toward another panel, and spaced apart from the other panel.

10. The battery pack of claim 9, wherein the first partition portion includes a plurality of partitions, and
wherein the plurality of partitions include:
a first partition extending from the first panel toward the second panel and spaced apart from the second panel; and
a second partition extending from the second panel toward the first panel and spaced apart from the first panel.

11. The battery pack of claim 9, wherein the discharge space includes:
a first space in communication with the first body hole and the discharge hole, and in which the first partition portion is arranged; and
a second space located below the first space, and
wherein the discharge portion further includes a separation portion located between the first space and the second space.

12. The battery pack of claim 1, wherein, when a fluid generated in one of the plurality of battery cells moves from the receiving space through the first cyclone portion to the discharge portion, one or more of the particles mixed in the fluid is captured on a bottom surface of the discharge space by their own weight.

13. The battery pack of claim 2, further comprising:
a second through-hole penetrating the one surface of the pack case; and
a second cyclone portion connected to the pack case and the discharge portion and causing the receiving space to communicate with the discharge space through the second through-hole and a second body hole which penetrates the discharge body to face the first body hole.

14. The battery pack of claim 13, wherein the second cyclone portion includes:
a second cyclone space in communication with the receiving space and the discharge space;
a second cyclone body forming the second cyclone space;
a second inlet hole penetrating the second cyclone body at a position corresponding to the second through-hole;
a second outlet hole penetrating the second cyclone body at a position corresponding to the second body hole; and
a second insertion tube in a pipe shape, located closer to the second inlet hole than to the second outlet hole, and penetrating the second cyclone body such that one end of the second insertion tube is located in the second cyclone space.

15. The battery pack of claim 14, wherein a diameter of an inner circumferential surface of the second cyclone space decreases in a direction toward the second outlet hole along an imaginary axis passing a center of the second outlet hole.

16. The battery pack of claim 14, wherein the one end of the second insertion tube is located between the second inlet hole and the second outlet hole.

17. The battery pack of claim 14, wherein the first cyclone portion further includes a first connection member in a pipe shape connecting the first inlet hole and the first through-hole, and
wherein the second cyclone portion further includes a second connection member in a pipe shape connecting the second inlet hole and the second through-hole.

18. The battery pack of claim 13, wherein the discharge portion includes:
a first panel facing the one surface of the pack case and forming one surface of the discharge body;
a second panel forming another surface of the discharge body which faces the first panel, and provided with the discharge hole;
a first connection panel provided with the first body hole and connecting the first panel and the second panel;
a second connection panel provided with the second body hole and connecting the first panel and the second panel;
a first partition portion located closer to the first connection panel than to the second connection panel, extending from one panel of the first panel and the second panel toward another panel, and spaced apart from the other panel; and
a second partition portion located closer to the second connection panel than to the first connection panel, extending from one panel of the first panel and the second panel toward another panel, and spaced apart from the other panel.

19. The battery pack of claim 18, wherein each of the first partition portion and the second partition portion includes a plurality of partitions, and
wherein the plurality of partitions include:
a first partition extending from the first panel toward the second panel and spaced apart from the second panel; and
a second partition extending from the second panel toward the first panel and spaced apart from the first panel.
